(19) United States
(12) Patent Application Publication
(10) Pub. No.: US 2009/0140532 A1
(43) Pub. Date: Jun. 4, 2009

(54) GLOVE BOX OF A MOTOR VEHICLE WITH A DOOR HAVING AN ADJUSTABLE CLOSED POSITION

(76) Inventors: Angela Falagario, Torino (IT); Nicolas Toppani, Torino (IT)

Correspondence Address: OSTROLENK FABER GERB & SOFFEN, 1180 AVENUE OF THE AMERICAS, NEW YORK, NY, 100368403, US

(21) Appl. No.: 12/257,498

(22) Filed: Oct. 24, 2008

(30) Foreign Application Priority Data
Oct. 29, 2007 (EP) 07425678.5

(51) Int. Cl. E05C 3/04

(52) U.S. Cl. 292/210

(57) ABSTRACT

A glove box of a motor vehicle, in particular for a dashboard, has a fixed structure defining an opening for a compartment which is closed by a movable door; a closing device holds the door in the closed position and has a latch, which is carried by the door and is movable to engage/disengage a retaining member carried by the fixed structure; the position of the retaining member can be adjusted in relation to the fixed structure, in order to adapt the position assumed by the external profile of the door when the door is held in the closed position; the closing device has an elastically deformable damping member, which is carried directly by the retaining member, or is carried by the door in a position such as to rest against the retaining member in the closed position.

The present invention relates to a glove box of a motor vehicle with a door having an adjustable closed position.

In particular, the present invention relates to a glove box provided in a dashboard, and the closed position of which can be adjusted during the assembly of the dashboard or when installing the dashboard in the motor vehicle in order to align the external profile of the door with the external profile of the rest of the dashboard.

### BACKGROUND OF THE INVENTION

Prior art solutions with the possibility of such adjustment comprise one or more rubber elements, which are fitted directly to a fixed structure of the dashboard and define a closing surface with which the door comes into contact when it is closed, in order to perform an anti-vibration function.

The closed position of the door is usually adjusted by fine-tuning a device that holds the door closed. Solutions are known in which the closing device comprises a retaining member carried by the fixed dashboard structure and a latch carried by the door and movable to engage/disengage the retaining member. The closed position of the door is adjusted by fine-tuning the position of the retaining member in relation to the fixed dashboard structure.

The prior art solutions described above are not very satisfactory, in that fine-tuning the position of the retaining member changes the degree of pressure and compression of the door on the rubber elements and, thus, alters the force that must be exerted by the user to close the door completely and trip the latch to engage the retaining member.

In particular, two opposite situations can occur: the rubber elements are not sufficiently compressed when the door is completely closed, so that the door becomes noisy owing to vibrations; or the rubber elements prevent the door from reaching its closed position.

### SUMMARY OF THE INVENTION

The purpose of the present invention is to produce a glove box of a motor vehicle with a door having an adjustable closed position, which makes it possible to overcome the drawbacks described above in a simple and cost-effective manner.

According to the present invention a glove box of a motor vehicle is produced comprising:
a fixed structure defining an opening of a compartment;
a door that is movable in relation to said fixed structure between a closed position, in which it closes said opening, and an open position, in which it leaves said opening open;
a closing device to hold said door in the closed position; said closing device comprising:
a) a retaining member carried by a first element defined by one of either said fixed structure or said door;
b) a latch carried by a second element defined by the other of either said door or said fixed structure, and movable between an extracted position, in which it engages said retaining member to hold said door in the closed position, and a retracted position, in which it is disengaged from said retaining member to allow said door to be opened;
c) at least one elastically deformable damping member, which defines a rest surface when said door is arranged in the closed position;
d) adjusting means to adjust the position of said retaining member in relation to said first element, so as to change the position assumed by the external profile of said door when said door is held in the closed position;
   characterized in that said elastically deformable damping member is carried by said retaining member or is carried by said second element in a position such as to rest against said retaining member in the closed position.

### BRIEF DESCRIPTION OF THE DRAWINGS

In order to better understand the present invention, a non-limiting preferred embodiment thereof will now be described by way of example with reference to the accompanying drawings, in which:

FIG. 1 is a schematic cross-section view, with parts removed for the sake of clarity, of a preferred embodiment of the glove box with a door having an adjustable closed position, according to the present invention; and

FIG. 2 is a perspective view of a detail of the glove box in FIG. 1.

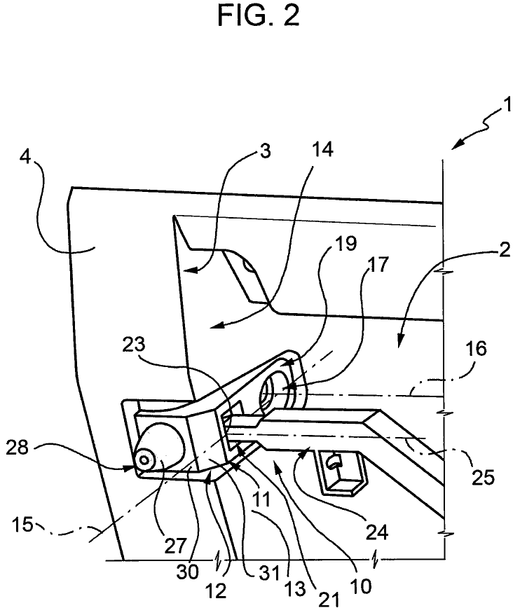

### DETAILED DESCRIPTION OF THE INVENTION

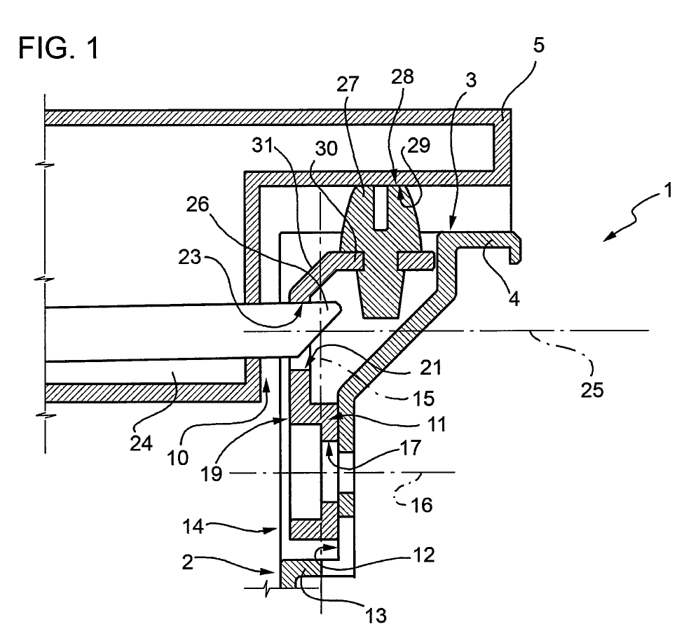

In FIG. 1, number 1 indicates, as a whole, a dashboard of a motor vehicle (partially illustrated).

The dashboard 1 comprises a glove box defining a compartment 2 (partially illustrated) having an opening 3.

The opening 3 is defined by a structure 4 of the glove box and can be opened/closed by means of a door 5.

The structure 4 is attached in a fixed position to a fixed structure of the dashboard 1 in a way that is not illustrated. According to an alternative embodiment, the glove box is an integral part of the dashboard, i.e. it is not a separate assembled part, and the structure 4 constitutes part of the fixed dashboard structure 1.

The door 5 comprises a lower portion, which is hinged to the structure 4 in a way that is not illustrated to pivot about an essentially horizontal axis between a raised position, in which the door 5 closes the opening 3, and a lowered position, in which the door 5 leaves the opening 3 free to allow a user to remove objects from or place objects in the compartment 2.

The glove box also comprises a closing device 10, which holds the door 5 in the raised position and comprises two parts, each connected to a relative side of the door 5 and of the compartment 2 and mutually symmetrical in relation to a vertical center-line plane of the door 5.

For each side of the door 5 and of the compartment 2, the device 10 comprises a retaining member 11 carried by the structure 4 and housed in a recess 12 obtained in a side wall 13 defining an inside surface 14 of the compartment 2. The recess 12 is elongated along a direction 15 essentially parallel to the direction in which the door 5 moves between the raised and lowered positions, and defines a guide for positioning the retaining member 11.

The retaining member 11 is held in position in the recess 12 by means of a connecting element, for example a screw. In particular, said screw is fixed to the wall 13 and extends along its own axis 16 through a slot 17. The axis 16 is at right angles to the direction 15 and is essentially horizontal; the slot 17 is obtained in the retaining member 11 and is elongated in the direction 15.

The slot 17 and the guide defined by the recess 12 allow the position of the retaining member 11 to be adjusted after loosening the screw, in order to adapt the position assumed by the external profile of the door 5 when the door 5 is in the raised position, as described more fully below.

The retaining member 11 has a side surface 19, arranged so that it is essentially flush with the surface 14 and defining the entrance of the slot 19 for said screw and the entrance of a seat 21, which is aligned with the slot 17 in the direction 15.

Towards the door 5, the seat 21 is delimited by a shoulder 23 defined by a surface or by an edge, transversal to the direction 15 and defining a supporting plane on which the essentially horizontal pivoting axis of the door 5 lies.

For each side of the door 5 and of the compartment 2, the device 10 comprises a latch 24, which is carried by the door 5 in a way that is known and not illustrated in detail, extends in a direction 25 parallel to the axis 16, and is movable in relation to the door 5 in the direction 25 between a forward position and a retracted position. In the forward position, a tip 26 of the latch 24 protrudes laterally to engage the seat 21 and rest against the shoulder 23, in order to hold the door 5 in the raised position; in a retracted position, the tip 26 of the latch disengages the seat 21 to allow the door 5 to be opened.

For each side of the door 5 and of the compartment 2, the device 10 comprises an elastically deformable member 27, preferably made of rubber. When the door 5 is arranged in the raised position, a front surface 28 of the member 27 defines a rest for a surface 29 of the door 5 and is compressed by the surface 29, in order to perform a vibration damping function when the compartment 2 is closed.

The member 27 is carried by the retaining member 11. In particular, the member 27 is directly connected to a front wall 30 of the retaining member 11 and in a fixed position, i.e. without the use of devices that would make it necessary to adjust the position of the member 27 in relation to the retaining member 11.

The member 27 protrudes in a cantilevered fashion from the wall 30 along the direction 15 and has an essentially truncated conical shape. The wall 30 is joined to the surface 19 by means of a ramp 31, which cooperates with the tip 26 of the latch 24 when the door 5 is raised (at the end of the closing stroke) making the latch 24 retract automatically against the action of a spring (not illustrated).

After passing the ramp 31, the tip 26 slides on an initial portion of the surface 19 until it snaps into the seat 21 owing to the effect of said spring.

According to an alternative embodiment, which is not illustrated, the member 27 is carried by the surface 29 of the door 5 in a relative fixed position and such as to rest against the wall 30 of the retaining member 11 in the closed position.

When the door 5 is in the raised position and closes the opening 3, the relative positions between the retaining member 11, the member 27 and the door 5 remain constant even if the position of the retaining member 11 is adjusted in relation to the wall 13 along the direction 15. In other words, the external profile of the door 5 and the position of the member 27 vary consistently, and there is no need for any specific adjustment of the position of the members 27 in relation to the structure 4 after adjusting the position of the retaining members 11.

Therefore, the degree of compression of the members 27 between the walls 30 and the door 5 is constant and is defined at the design stage, essentially on the basis of the dimensions of the members 27, the position of the latches 24 in relation to the door 5, and the distance between the shoulder 23 and the respective walls 30.

As a consequence, on the one hand, the reaction due to the compression of the members 27 and felt by the user while manually raising and closing the door 5 is constant on each dashboard that is produced and assembled on motor vehicles. On the other hand, there is no risk of any clearance remaining in correspondence with the surfaces 28.

Lastly, it is clear that modifications and variations may be made to the glove box described and illustrated herein without departing from the scope of the present invention, as set forth in the appended claims.

In particular, the latch could be carried by the structure 4 and a corresponding adjustable retaining member could be carried by the door 5.

Moreover, the device 10 could comprise a single latch and a single retaining member arranged for example on the upper edge of the door 5.

1. Glove box of a motor vehicle comprising:
a fixed structure (4) defining an opening (3) of a compartment (2);
a door (5) that is movable in relation to said fixed structure (4) between a closed position, in which it closes said opening (3), and an open position, in which it leaves said opening (3) open;
a closing device (10) to hold said door (5) in the closed position; said closing device (10) comprising:
a) a retaining member (11) carried by a first element (4) defined by one of either said fixed structure or said door;
b) a latch (24) carried by a second element (5) defined by the other of either said door or said fixed structure, and movable between an extracted position, in which it engages said retaining member (11) to hold said door (5) in the closed position, and a retracted position, in which it is disengaged from said retaining member (11) to allow said door (5) to be opened;
c) at least one elastically deformable damping member (27), which defines a rest surface (28) when said door (5) is arranged in the closed position;
d) adjusting means (12) to adjust the position of said retaining member (11) in relation to said first element (4), so as to adapt the position assumed by the external profile of said door (5) when said door (5) is held in the closed position;
characterized in that said elastically deformable damping member (27) is carried by said retaining member (11) or is carried by said second element (5) in a position such as to rest against said retaining member (11) in the closed position.

2. Glove box according to claim 1, characterized in that said retaining member (11) is fixed to said fixed structure (4) in a position that can be adjusted by means of said adjusting means (12), and in that said elastically deformable member (27) is directly connected to said retaining member (11).

3. Glove box according to claim 2, characterized in that said elastically deformable damping member (27) is coupled to said retaining member (11) in a fixed position.

4. Dashboard (1) of a motor vehicle comprising a glove box produced according to claim 1.

5. Dashboard according to claim 4, characterized in that said glove box defines a separate assembled part.

6. Dashboard according to claim 4, characterized in that the fixed structure (4) of said glove box defines part of a fixed structure of said dashboard (1).
